(19) United States
(12) Patent Application Publication
(10) Pub. No.: US 2014/0322432 A1
(43) Pub. Date: Oct. 30, 2014

(54) ASSEMBLY METHOD OF A VOICE COIL MOTOR AND ASSEMBLY DEVICE THEREOF

(71) Applicant: SAE Magnetics, Hong Kong (CN)

(72) Inventors: Chun Bai LI, DongGuan (CN); Can Hua Chen, DongGuan (CN); Yiu Sing Ho, Hong Kong (CN); Murata Shuji, Hong Kong (CN)

(21) Appl. No.: 13/916,035

(22) Filed: Jun. 12, 2013

(30) Foreign Application Priority Data
Apr. 26, 2013 (CN) 201310150068.3

(51) Int. Cl. H02K 15/12

(52) U.S. Cl. CPC H02K 15/12
USPC 427/8; 427/207.1; 427/558; 118/712; 118/713

(57) ABSTRACT

An assembly method of a voice coil motor for assembling component parts of a voice coil motor includes the following steps: (1) providing identifiable glue, and the identifiable glue is made by mixing colorable substance or phosphor into transparent glue; (2) coating the identifiable glue on connecting positions of the component parts; (3) curing the identifiable glue, and identifying the identifiable glue simultaneously to check dispensing and curing effect of the component parts. The assembly method can cure and check the voice coil motor simultaneously, thereby it can improve the production efficiency, reduce the manpower, and promote the development of the automated production line. An assembly device is also disclosed.

### FIELD OF THE INVENTION

The present invention relates in general to voice coil motor, and more particularly to an assembly method of a voice coil motor and an assembly device thereof.

### BACKGROUND OF THE INVENTION

Voice coil motor has advantages of small size, less power consumption, low price, etc, which is suitable for the actuator of some electronic products, such as digital cameras, mobile phones, digital video cameras, etc.

Conventional voice coil motor mainly includes a bottom, a fixed assembly and a movable assembly installed in the fixed assembly movably. The movable assembly includes a lens holder, a coil that twins around a side of the lens holder, and at least one spring plate connected to at least one end face of the lens holder. The fixed assembly includes a fixed frame and at least one magnet installed in the fixed frame. The bottom is arranged for pushing the movable assembly, the lens holder is arranged for carrying some components, such as lens cone, focusing lens group, or zoom lens group, the spring plate can protect the lens cone, the focusing lens group or the zoom lens group, etc. When the coil of the movable assembly is energized, a magnetic force is produced between the coil and the magnet of the fixed assembly, thereby making the movable assembly to move in the fixed frame to change the distance between the camera sensor and the lens cone, the focusing lens group or the zoom lens group, in turn realizing the function of focusing or zoom.

The component parts mentioned-above, such as the bottom, the lens holder, the coil, the spring plate, the fixed frame and the magnet, are bonded together by a dispensing unit, and then cured and checked by a curing checking unit 20′ as shown in FIGS. 1 and 2. The curing checking unit 20′ includes a curing unit 22′, a checking unit 24′, and a work table 26′. The work table 26′ is arranged for placing the component parts that are about to be or have been processed by the curing checking unit 20′. The curing method of the curing unit 22′ is usually processed by ultraviolet (UV). The curing unit 22′ has at least one UV irradiation unit, which is arranged to irradiate the component parts of the voice coil motor 30′ for curing. The checking unit 24′ is a microscope, which is arranged for manual visual checking dispensing and curing effect of the component parts.

However, most component parts of the voice coil motor need to be dispensed and cured during the assembly process, and each of which always needs manual visual checking by the microscope thereafter. This method or device has the following defects: (1) the glue used in the process of dispensing is transparent glue, so the accuracy of manual visual checking by microscope on the transparent glue is low; (2) the process is complex, once a component part is applied with glue, it must be cured by the curing unit, and then checked by the microscope, the process is time consuming, and the production efficiency is low; (3) the degree of automation is low, and a large amount of manpower is needed.

Hence, it is desired to provide an improved assembly method and an assembly device of a voice coil motor to overcome the above-mentioned drawbacks.

### SUMMARY OF THE INVENTION

One objective of the present invention is to provide an assembly method of a voice coil motor, which can cure and check a voice coil motor simultaneously, with a high degree of automation.

Another objective of the present invention is to provide an assembly device of a voice coil motor, which can cure and check a voice coil motor simultaneously, with a high degree of automation.

To achieve above objectives, an assembly method of a voice coil motor adapted for assembling component parts of a voice coil motor includes steps of:

(1) providing identifiable glue;

(2) coating the identifiable glue on connecting positions of the component parts;

(3) curing the identifiable glue, and identifying the identifiable glue simultaneously to check dispensing and curing effect of the component parts.

Selectively, the identifiable glue is made by mixing colorable substance into transparent glue. Due to the colorable substance, the identifiable glue presents color, and then the identifiable glue is identified according to the color of the identifiable glue. The kind and the depth of the color are not limited, thus having wide application.

Selectively, the identifiable glue is made by mixing phosphor into transparent glue, and the identifiable glue is self-luminous in the process of curing, and then the identifiable glue is identified according to its self-luminous property.

Specifically, the phosphor is toluylene-type phosphor, coumarin-type phosphor, pyrazoline-type phosphor, benzoxazepine-type phosphor, or phthalimide-type phosphor.

Preferably, the assembly method further includes curing the identifiable glue by ultraviolet (UV).

Preferably, the assembly method further includes obtaining information of the identifiable glue by imaging, and then identifying the information to check the dispensing and curing effect of the component parts.

an assembly device of a voice coil motor, adapted for assembling component parts of a voice coil motor, includes a dispensing unit and a curing checking unit, the dispensing unit is arranged for coating identifiable glue on connecting positions of the component parts, the curing checking unit includes a curing unit arranged for curing the identifiable glue and a checking unit arranged for identifying the identifiable glue to check dispensing and curing effect of the component parts.

Selectively, the identifiable glue is made by mixing colorable substance into transparent glue. Due to the colorable substance, the identifiable glue presents color, and the checking unit is arranged to identify the identifiable glue according to the color of the identifiable glue. The kind and the depth of the color are not limited, thus having wide application.

Selectively, the identifiable glue is made by mixing phosphor into transparent glue, and the curing unit is arranged to make the identifiable glue self-luminous, and the checking unit is arranged to identify the identifiable glue according to the self-luminous property of the identifiable glue.

Specifically, the phosphor is toluylene-type phosphor, coumarin-type phosphor, pyrazoline-type phosphor, benzoxazepine-type phosphor, or phthalimide-type phosphor.

Preferably, the curing unit includes at least one UV irradiation unit.

As an embodiment of the present invention, the checking unit includes an information acquisition equipment and an information processing equipment.

Preferably, the information acquisition equipment is monochrome camera or color camera.

Preferably, the information processing equipment includes image analysis tool, which can process the information obtained by the information acquisition equipment.

In comparison with the prior art, coating identifiable glue on connecting positions of component parts, and then curing the identifiable glue, and identifying the identifiable glue simultaneously to check dispensing and curing effect of the component parts. Because the identifiable glue has the property of identification, thus it can be checked more easily than transparent glue, which improves the accuracy of manual visual checking by microscope on the transparent glue. Furthermore, the curing unit and the checking unit can work simultaneously and at the same station, thus, the working procedure is shortened, the production efficiency is improved. In addition, during the curing and checking processes, worker, microscope and worktable are not needed, thereby, not only the manpower is reduced, the space is saved, but also the full automated production line has been developed.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional curing checking unit;

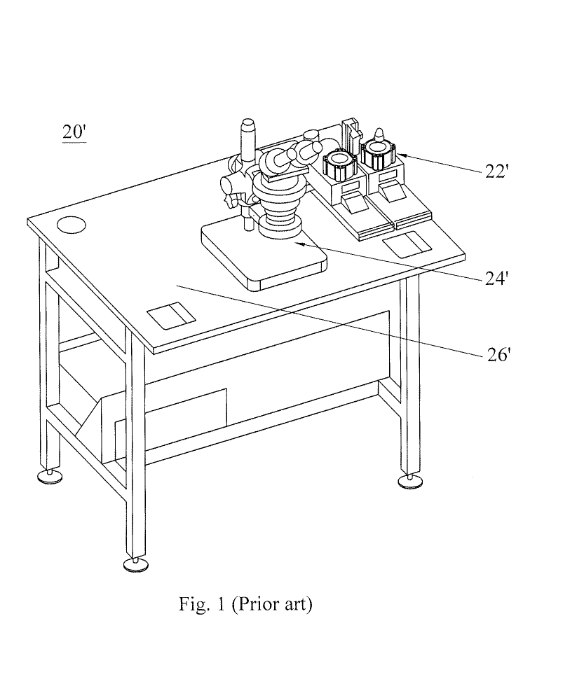

FIG. 2 is a perspective view of a conventional curing unit;

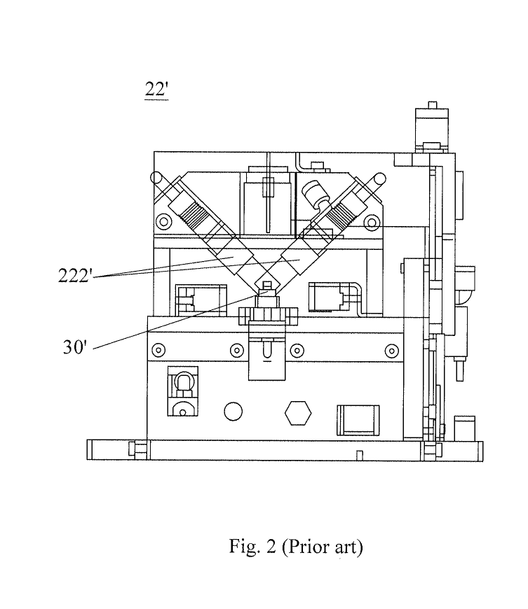

FIG. 3 is a schematic view of an assembly device of a voice coil motor of the present invention;

FIG. 4 is a perspective view of a curing checking unit of an assembly device of a voice coil motor of the present invention;

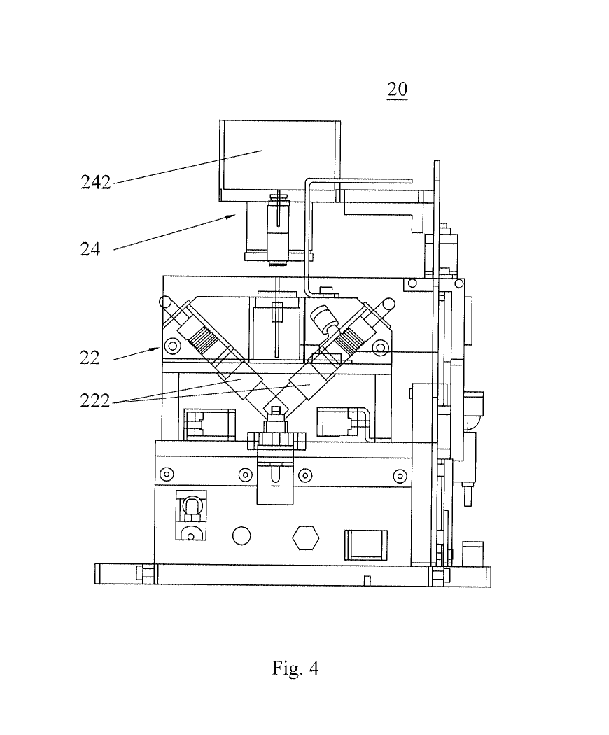

FIG. 5 is a exploded view of a voice coil motor of the present invention, and shows component parts of a voice coil motor; and

FIG. 6 illustrates a flowchart view of an assembly method of a voice coil motor of the present invention.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the present invention is directed to an assembly method and an assembly device of a voice coil motor, which can cure and check the voice coil motor simultaneously, thereby it can improve the production efficiency, reduce the manpower, and promote the development of the automated production line.

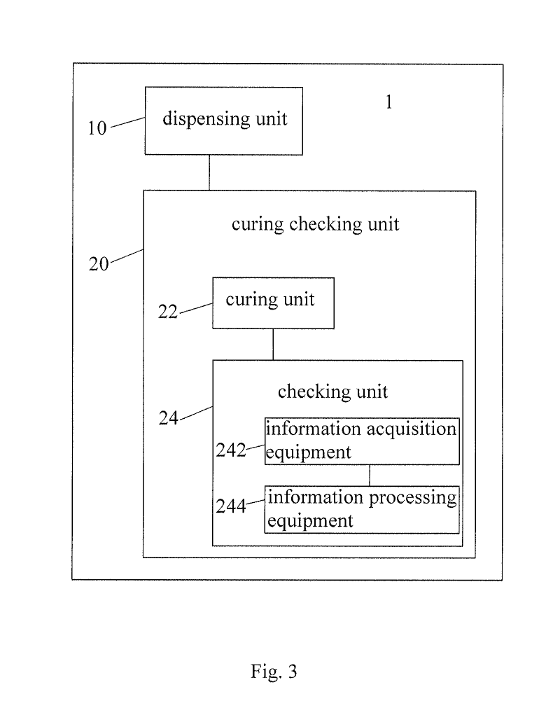

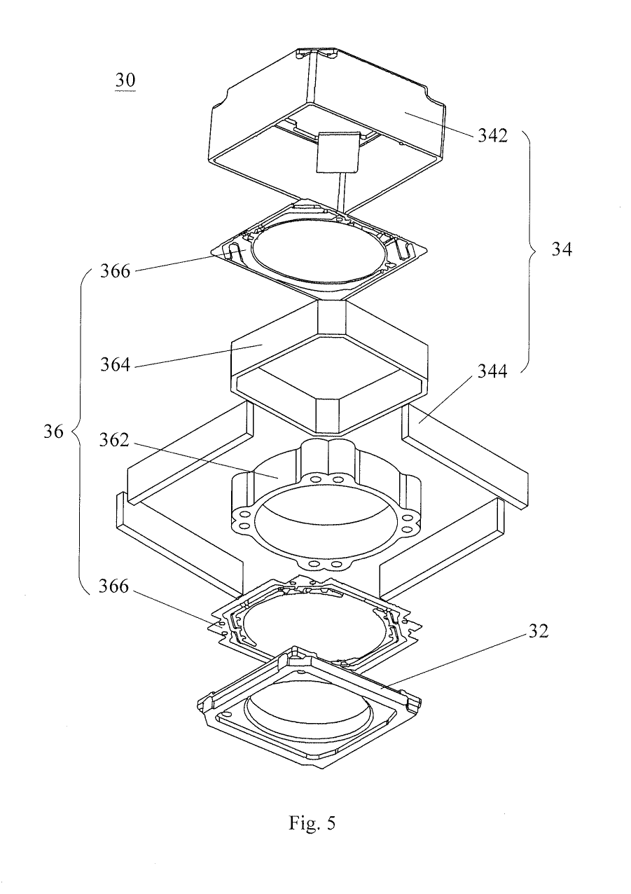

Referring to FIG. 3, the assembly device 1 of the present invention is arranged to assemble the component parts of the voice coil motor 30. Concretely, as shown in FIG. 5, the component part of the voice coil motor 30 mainly includes a bottom 32, a fixed assembly 34 and a movable assembly 36 installed in the fixed assembly 34 movably. The movable assembly 36 includes a lens holder 362, a coil 364 that twins around a side of the lens holder 362, and at least one spring plate 366 connected to at least one end face of the lens holder 362, specifically, the movable assembly 36 has two spring plates 366. The fixed assembly 34 includes a fixed frame 342 and at least one magnet 344 installed in the fixed frame 342. The bottom 32 is arranged for pushing the movable assembly 36, the lens holder 362 is arranged for carrying some components, such as lens cone, focusing lens group, or zoom lens group (not shown), the spring plate 366 can protect the lens cone, the focusing lens group or the zoom lens group, etc. When the coil 364 of the movable assembly 36 is energized, a magnetic force is produced between the coil 364 and the magnet 344 of the fixed assembly 34, thereby making the movable assembly 36 to move in the fixed frame 342 to change the distance between the camera sensor (not shown) and the lens cone, the focusing lens group or the zoom lens group, in turn realizing the function of focusing or zoom.

The component parts mentioned-above, such as the bottom 32, the lens holder 362, the coil 364, the spring plate 366, the fixed frame 342 and the magnet 344, are assembled together by the assembly device 1 as shown in FIG. 3. The Assembly device 1 includes a dispensing unit 10 and a curing checking unit 20, the dispensing unit 10 is arranged for coating identifiable glue on connecting positions of the component parts, the curing checking unit 20 includes a curing unit 22 and a checking unit 24, the curing unit 22 is arranged for curing the identifiable glue, and the checking unit 24 is arranged for identifying the identifiable glue simultaneously to check dispensing and curing effect of the component parts. Concretely, the identifiable glue is used to bond the component parts of the voice coil motor 30, the connecting positions of the component parts is different due to different product type, so don't explained here. While, it is very important to apply glue on the connecting positions precisely, the key to ensure the stability of the voice coil motor 30 is to avoid the glue thereon too little or too much.

Wherein, the identifiable glue is different from the conventional transparent glue, and has the property of identification. Specifically, the identifiable glue has the property of identification by machine vision. That is, it can be identified by the checking unit 24 without microscope. As an embodiment of the present invention, the identifiable glue is made by mixing colorable substance into transparent glue. Due to the colorable substance, the identifiable glue presents color. The kind and the depth of the color are not limited, thus having wide application. As another embodiment of the present invention, the identifiable glue is made by mixing phosphor into transparent glue, and the phosphor is toluylene-type phosphor, coumarin-type phosphor, pyrazoline-type phosphor, benzoxazepine-type phosphor, or phthalimide-type phosphor. With UV exposure, the toluylene-type phosphor, the coumarin-type phosphor, and the phthalimide-type phosphor irradiate blue fluorescence, the pyrazoline-type phosphor irradiates green fluorescence, and the benzoxazepine-type phosphor irradiates red fluorescence. Preferably, the transparent glue mentioned-above is UV glue, and can be cured by UV exposure. The identifiable glue is made by mixing colorable substance or phosphor into transparent glue at a weight ratio, the range of the weight ratio can be obtained by experiment, and don't explain here.

Firstly, a component part is applied with identifiable glue by the dispensing unit 10 on the connecting positions thereof, and then the curing unit 22 cures the identifiable glue. Concretely, the curing unit 22 includes at least one UV irradiation unit 222, which is arranged to irradiate the identifiable glue for curing, meanwhile, the identifiable glue containing the phosphor is self-luminous in UV exposure, but the identifiable glue containing the colorable substance can't. The curing unit 22 cures the identifiable glue, and the checking unit 24 checks the dispensing and curing effect of the component parts at the same time. The checking unit 24 includes an information acquisition equipment 242 and an information processing equipment 244, the information acquisition equipment 242 can be monochrome camera or color camera, and the information processing equipment 244 includes image analysis tool, such as visual image processing software, concretely, computer binaryzation data processing software, which can process the information obtained by the information acquisition equipment 242. Concretely, the identifiable glue has the property of identification by machine vision due to the color it presents or the self-luminous property thereof, thus the information acquisition equipment 242 can obtain the color information the identifiable glue presents or the luminescence information irradiated therefrom in UV exposure, such as the color image information or the luminescence image information took by the monochrome camera or the color camera. The information obtained by the information acquisition equipment 242 is transferred to the information processing equipment 244 to process for edge data and area data of the identifiable glue, thereby checking the dispensing and curing effect of the component parts.

In conclusion, the identifiable glue is applied on connecting positions of component parts of voice coil motor 30, and then cured by the curing unit 22, identified by the checking unit 24 simultaneously, thereby checking the dispensing and curing effect of the component parts. Because the identifiable glue has the property of identification, thus it can be checked more easily than transparent glue, which improves the accuracy of manual visual checking by microscope on the transparent glue. Furthermore, the curing unit 22 and the checking unit 24 can work simultaneously and at the same station, thus, the working procedure is shortened, the production efficiency is improved. In addition, during the curing and checking processes, worker, microscope and worktable are not needed, thereby, not only the manpower is reduced, the space is saved, but also the automated production line has been developed.

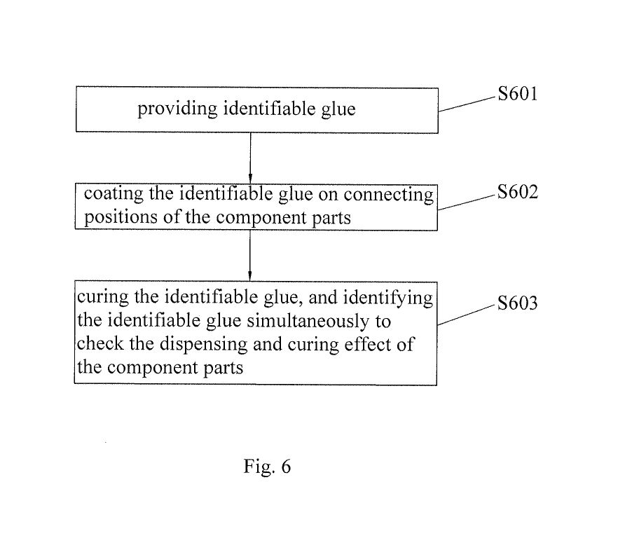

FIG. 6 shows a flowchart of an assembly method of a voice coil motor for assembling component parts of a voice coil motor, including steps of:

S601, providing identifiable glue;

S602, coating the identifiable glue on connecting positions of the component parts;

S603, curing the identifiable glue, and identifying the identifiable glue simultaneously to check the dispensing and curing effect of the component parts.

Selectively, the identifiable glue is made by mixing colorable substance into transparent glue. Due to the colorable substance, the identifiable glue presents color, and then the identifiable glue is identified according to the color of the identifiable glue.

Selectively, the identifiable glue is made by mixing phosphor into transparent glue, and the identifiable glue is self-luminous in the process of curing, and then the identifiable glue is identified according to its self-luminous property.

Specifically, the phosphor is toluylene-type phosphor, coumarin-type phosphor, pyrazoline-type phosphor, benzoxazepine-type phosphor, or phthalimide-type phosphor.

Preferably, the assembly method further includes curing the identifiable glue by ultraviolet (UV).

Preferably, the assembly method further includes obtaining information of the identifiable glue by imaging, and then identifying the information to check the dispensing and curing effect of the component parts.

In conclusion, the method of present invention applies identifiable glue on connecting positions of component parts, and then cures the identifiable glue, and identifies the identifiable glue simultaneously to check dispensing and curing effect of the component parts. Because the identifiable glue has the property of identification, thus it can be checked more easily than transparent glue, which improves the accuracy of manual visual checking by microscope on the transparent glue. Furthermore, the curing and checking processes work simultaneously and at the same station, thus, the working procedure is shortened, the production efficiency is improved. In addition, during the curing and checking processes, worker, microscope and worktable are not needed, thereby, not only the manpower is reduced, the space is saved, but also the automated production line has been developed.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An assembly method of a voice coil motor, adapted for assembling component parts of a voice coil motor, and the assembly method comprising steps of:
providing identifiable glue;
coating the identifiable glue on connecting positions of the component parts; and
curing the identifiable glue, and identifying the identifiable glue simultaneously to check dispensing and curing effect of the component parts.

2. The assembly method according to claim 1, wherein the identifiable glue is made by mixing colorable substance into transparent glue.

3. The assembly method according to claim 1, wherein the identifiable glue is made by mixing phosphor into transparent glue, and the identifiable glue is self-luminous in the process of curing, and then the identifiable glue is identified according to its self-luminous property.

4. The assembly method according to claim 3, wherein the phosphor is toluylene-type phosphor, coumarin-type phosphor, pyrazoline-type phosphor, benzoxazepine-type phosphor, or phthalimide-type phosphor.

5. The assembly method according to claim 1, further comprising curing the identifiable glue by ultraviolet.

6. The assembly method according to claim 1, further comprising obtaining information of the identifiable glue by imaging, and then identifying the information to check the dispensing and curing effect of the component parts.

7. An assembly device of a voice coil motor, adapted for assembling component parts of a voice coil motor, and the assembly device comprising:
a dispensing unit, arranged for coating identifiable glue on connecting positions of the component parts;
a curing checking unit, comprising a curing unit arranged for curing the identifiable glue and a checking unit arranged for identifying the identifiable glue to check dispensing and curing effect of the component parts.

8. The assembly device according to claim 7, wherein the identifiable glue is made by mixing colorable substance into transparent glue, and the checking unit is arranged to identify the identifiable glue according to the color of the identifiable glue.

9. The assembly device according to claim 7, wherein the identifiable glue is made by mixing phosphor into transparent glue, and the curing unit is arranged to make the identifiable glue self-luminous, and the checking unit is arranged to identify the identifiable glue according to its self-luminous property.

10. The assembly device according to claim 9, wherein the phosphor is toluylene-type phosphor, coumarin-type phosphor, pyrazoline-type phosphor, benzoxazepine-type phosphor, or phthalimide-type phosphor.

11. The assembly device according to claim 7, wherein the curing unit comprises at least one ultraviolet irradiation unit.

12. The assembly device according to claim 7, wherein the checking unit comprises an information acquisition equipment and an information processing equipment.

13. The assembly device according to claim 12, wherein the information acquisition equipment is monochrome camera or color camera.

14. The assembly device according to claim 12, wherein the information processing equipment comprises image analysis tool.
